(19) United States
(12) Patent Application Publication
(10) Pub. No.: US 2012/0223893 A1
(43) Pub. Date: Sep. 6, 2012

(54) TOUCH PANEL AND TOUCH PAD

(76) Inventors: Chen-Wei Yang, Kaohsiung City (TW); Wen-Tsung Lin, Tainan City (TW); Hsin-Wei Shich, New Taipei City (TW)

(21) Appl. No.: 13/082,031

(22) Filed: Apr. 7, 2011

(30) Foreign Application Priority Data
Mar. 4, 2011 (TW) 100107304

(51) Int. Cl. G06F 3/041

(52) U.S. Cl. 345/173

(57) ABSTRACT

A touch panel and a plurality of touch pads thereof are disclosed. Each touch pad includes a plurality of the same edges. Each edge includes two edge ends, an edge center, at least one convex, and at least one concave. A line between the two edge ends is defined as a reference line. The edge center is located at the center of the reference line. A first region is surrounded by the at least one convex and the reference line. A second region is surrounded by the at least one concave and the reference line. The at least one convex and the at least one concave are symmetrical to the edge center.

### BACKGROUND OF THE INVENTION

### Cross-Reference to Related Application

This application claims priority based on Taiwanese Patent Application No. 100107304, filed on Mar. 4, 2011, the disclosure of which is incorporated herein by reference in its entirety.

### FIELD OF THE INVENTION

The invention relates to the touch technology; in particular, to a touch pad capable of enhancing the sensitivity of the touch panel effectively and a touch panel including the touch pad.

DESCRIPTION OF THE PRIOR ART

In recent years, with the development of the touch technology, inputting by touch has become the main trend input way of the human machine interface. As a new generation of smart phones and other consumer electronics products come out, the touch screen has become more popular, the touch panel market for the future is also very optimistic about growth prospects. Especially, after the next generation Windows operating system can support the touch panel, the touch panel can be applied not only in small and medium size screen of mobile phones, but also in ten times larger size monitor of personal computers, therefore, the touch panel has great potential business opportunities.

In general, the touch panels can be divided into different types, such as the resistance type, the capacitance type, the ultrasonic type, optical type, according to their touch sensing theorems. Wherein, the capacitance type touch panel is better than the resistance type touch panel in many respects such as transmittance, reaction speed, durability, and appearance, and the capacitance type touch panel also has multi-touch capabilities. Therefore, it is generally optimistic about the capacitive touch panel can gradually replace the traditional resistive touch technology on the market.

Please refer to FIG. 1. FIG. 1 illustrates a schematic diagram of a conventional capacitance type touch panel including a plurality of touch pads. As shown in FIG. 1, the capacitance type touch panel 1 includes a plurality of touch pads 10 alternately aligned in vertical direction and horizontal direction as a diamond structure. Each touch pad 10 is a quadrilateral and the four edges 101˜104 of the quadrilateral are the same and all straight lines. The plurality of touch pads 10 is used to sense the touch gestures of an item (e.g., a finger or a touch pen tip) and the touch point location formed on the capacitance type touch panel 1 according to the change of parasitic capacitance generated when the item touches the capacitance type touch panel 1.

Since the above-mentioned diamond structure has a symmetrical shape, the driving direction and the sensing direction on the capacitance type touch panel 1 can be exchanged. For example, the vertical direction and the horizontal direction can be the driving direction and the sensing direction respectively, and vice versa. In practical applications, the diamond structure of the capacitance type touch panel 1 can be realized by using a single layer of ITO glass and a bridge.

Because the mutual capacitance is determined by the length and distance of the two adjacent edges of the touch pad 10 staggered by the driving channel and the sensing channel, that is to say, the mutual capacitance is determined by the contact area between the driving channel and the sensing channel. And, the mutual capacitance determines the sensitivity of the touch pad 10 for sensing the capacitance changing amount generated when touching. If the mutual capacitance increases, the touch sensitivity of the touch pad 10 will also increase. However, for the touch pad 10 having the diamond structure shown in FIG. 1, its mutual capacitance is hard to be adjusted since it is limited by the lengths of the four edges 101˜104 of the touch pad 10, that is to say, indirectly limited by the size of the panel and the number of the sensing pins.

Although the capacitance type touch panel can also use another touch pad having the strip structure to increase the sensitivity of the touch pad and improve the signal to noise ratio (SNR) by adjusting the size of the overlapping region between the driving channel and the sensing channel and the distance between two layers of ITO glass, in practical applications, this strip structure should use two layers of ITO glass not only leading to the transmittance of the capacitance type touch panel drop but also causing high production cost.

Therefore, the invention provides a touch panel and a touch pad thereof to solve the above-mentioned problems occurred in the prior arts.

### SUMMARY OF THE INVENTION

A scope of the invention is to provide a touch pad. In an embodiment, the touch pad is applied in a touch panel. The touch pad includes a plurality of the same edges. Each edge includes two edge ends, an edge center, at least one convex, and at least one concave. A line between the two edge ends is defined as a reference line. The edge center is located at the center of the reference line. A first region is surrounded by the at least one convex and the reference line. A second region is surrounded by the at least one concave and the reference line. The at least one convex and the at least one concave are symmetrical to the edge center.

In practical applications, the area of the first region and the area of the second region can be the same or not. The number of the at least one convex and the number of the at least one concave are the same. A first convex of the at least one convex and a first concave of the at least one concave are corresponding and symmetrical to the edge center, the first convex and the first concave have a first shape in common. The first convex and the first concave are located at two sides of the edge center respectively. The first shape is selected from one of a group formed by a strip, a square, a triangle, an arc, a polygon, a sawtooth form, and an irregular geometric shape.

A second convex of the at least one convex and a second concave of the at least one concave are corresponding and symmetrical to the edge center, the second convex and the second concave have a second shape in common. The first shape and the second shape are the same or different. A sensitivity and a signal-noise ratio of the touch panel can be adjusted by changing the design of the at least one convex and the at least one concave.

Another scope of the invention is to provide a touch panel. In an embodiment, the touch panel includes a plurality of touch pads. The touch pad includes a plurality of the same edges. Each edge includes two edge ends, an edge center, at least one convex, and at least one concave. A line between the two edge ends is defined as a reference line. The edge center is located at the center of the reference line. A first region is surrounded by the at least one convex and the reference line. A second region is surrounded by the at least one concave and the reference line. The at least one convex and the at least one concave are symmetrical to the edge center.

The plurality of touch pads includes a plurality of first touch pads aligned along a first direction and a plurality of second touch pads aligned along a second direction. A first touch pad of the plurality of first touch pads and a second touch pad of the plurality of second touch pads are embedded to increase a contact area and a mutual capacitance between the first touch pad and the second touch pad.

Compared to prior arts, the touch panel and its touch pad of the invention is to change the shape of the edges of the touch pads and maintain the original area of the touch pad, so that the touch pads of vertical direction and horizontal direction can be embedded each other to increase the touch area and the mutual capacitance between the driving channel and the sensing channel, and the sensitivity of the touch pad can be also enhanced.

In addition, under the condition of setting the non-driving channels or the non-sensing channels of the touch panel in the invention, the capacitance of the sensing channel toward ground can be increased, so that its capability of resisting noises can be enhanced to effectively improve the SNR of the entire touch sensing system. The touch panel and its touch pad of the invention can not only increase the sensitivity of the touch pads and improve the SNR to solve the problem of the conventional diamond structure, but also keep the advantage of the conventional diamond structure made by using a single layer of ITO glass and a bridge. Therefore, the competitiveness of the touch panel on the market can be largely enhanced.

The advantage and spirit of the invention may be understood by the following detailed descriptions together with the appended drawings.

### BRIEF DESCRIPTION OF THE APPENDED DRAWINGS

FIG. 1 illustrates a schematic diagram of a conventional capacitance type touch panel including a plurality of touch pads.

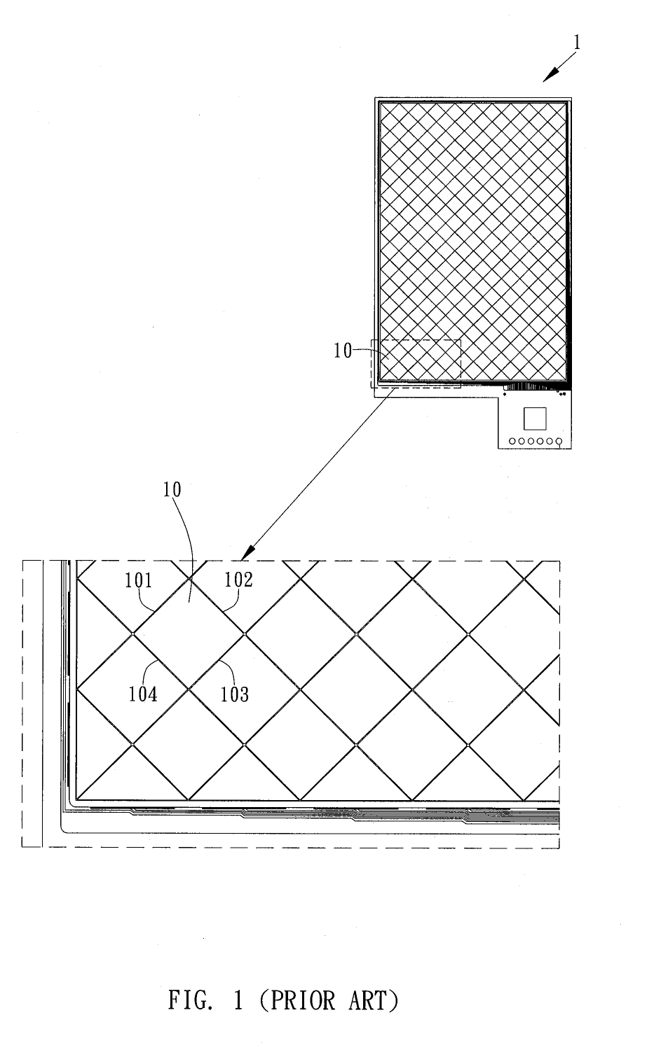

FIG. 2 illustrates a schematic diagram of the touch panel including the plurality of touch pads in the invention.

FIG. 3 illustrates a schematic diagram of the touch pad 20 of FIG. 2.

FIG. 4 illustrates a schematic diagram of the touch pad having arc shape convexes and concaves.

### DETAILED DESCRIPTION OF THE INVENTION

The invention provides a touch panel and a touch pad thereof, it is to change the shape of the edges of the touch pads and maintain the original area of the touch pad, so that the touch pads of vertical direction and horizontal direction can be embedded each other to increase the touch area and the mutual capacitance between the driving channel and the sensing channel, and the sensitivity of the touch pad can be also enhanced.

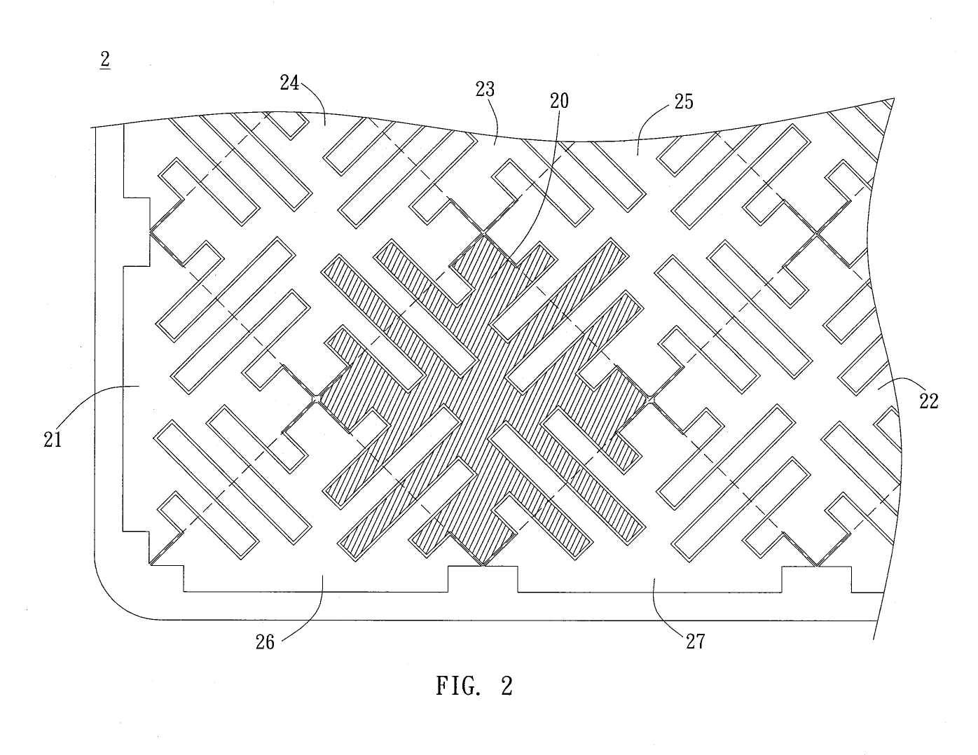

An embodiment of the invention is a touch panel. In this embodiment, the touch panel is a capacitance type touch panel, and the touch panel includes a plurality of touch pads. Please refer to FIG. 2. FIG. 2 illustrates a schematic diagram of the touch panel including the plurality of touch pads in the invention.

As shown in FIG. 2, the touch panel 2 includes a plurality of touch pads 20˜27, and the plurality of touch pads 20˜27 is alternately aligned in a vertical direction and a horizontal direction to be used as driving channels and sensing channels respectively. For example, if the touch pads 20, 21, and 22 aligned along the horizontal direction are used as the driving channels, then the touch pads 24, 25, 26, and 27 aligned along the vertical direction will be used as the sensing channels. On the contrary, if the touch pads 20, 21, and 22 aligned along the horizontal direction are used as the sensing channels, then the touch pads 24, 25, 26, and 27 aligned along the vertical direction will be used as the driving channels.

In practical applications, the plurality of touch pads 20˜27 can be disposed on a circuit board of the touch panel 2. The number of the touch pads of the touch panel 2 has no limitations; therefore, it can be designed based on the size of the touch panel 2 and practical requirements. The material of the touch pad of the touch panel 2 is the same with that of the ordinary touch pad.

As shown in FIG. 2, it should be noticed that the touch pad 20 will be embedded with the touch pads 24, 25, 26, and 27 to increase the mutual capacitance between the touch pad 20 and the touch pads 24, 25, 26, and 27 to enhance its sensitivity.

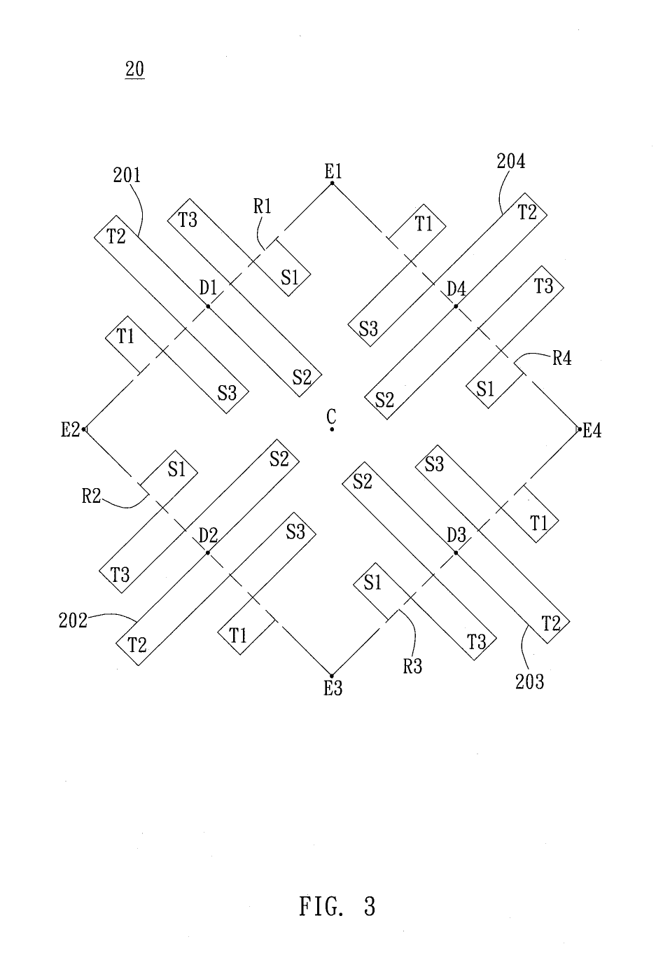

Then, please refer to FIG. 3. FIG. 3 illustrates a schematic diagram of the touch pad 20 of FIG. 2. As shown in FIG. 3, the touch pad 20 includes a pad center C and four the same edges 201˜204. Since the edges 201˜204 are the same and symmetrical to the pad center C, therefore, only the edge 201 is take as an example to explain, and so on.

As shown in FIG. 3, the edge 201 includes two edge ends E1 and E2, an edge center D1, at least one convex T1˜T3, and at least one concave S1˜S3. A line connecting the two edge ends E1 and E2 is defined as a reference line R1. The edge center D1 is located at a center of the reference line R1. The at least one convex T1˜T3 and the at least one concave S1˜S3 are symmetrical to the edge center D1. In detail, the convex T1 and the concave S1 are symmetrical to the edge center D1; the convex T2 and the concave S2 are symmetrical to the edge center D1; the convex T3 and the concave S3 are symmetrical to the edge center D1.

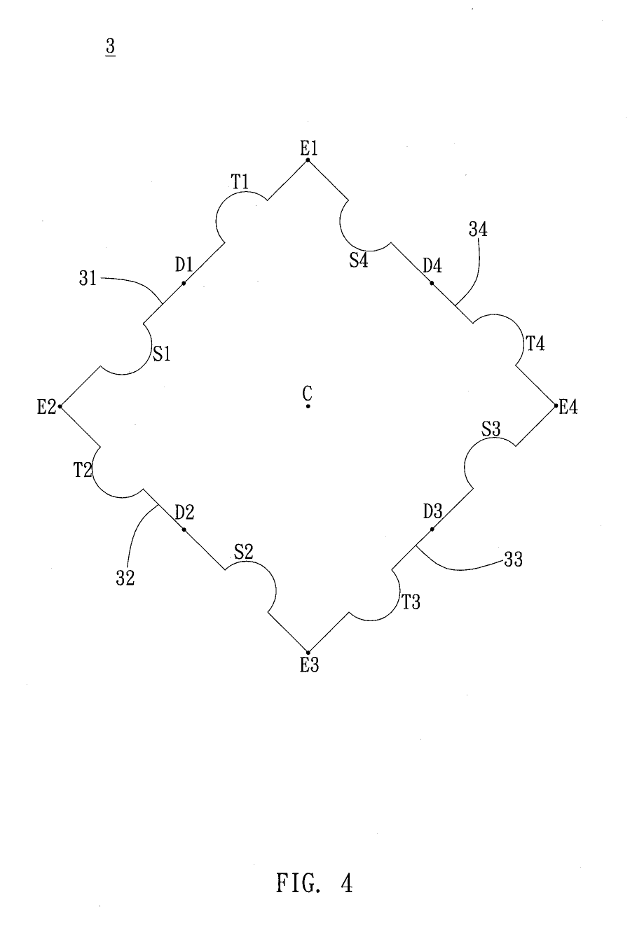

In practical applications, the number of the convex and the number of the concave of the edge 201 are not limited to three as shown in the above-mentioned example. The only limitation of the invention is that the number of the convex and the number of the concave are the same and the convex and the concave can be symmetrical to the edge center D1. In addition, the symmetrical convex and concave should have the same shape, for example, the shape of the convex T1 and the shape of the concave S1 are the same, and the shape can be a strip, a square, a triangle, an arc (as shown in FIG. 4), a polygon, a sawtooth form, an irregular geometric shape, or any other geometric shapes without any special limitations. As to the convex or the concave not symmetrical to each other, such as the convex T1 and the convex T2, the concave S1 and the concave S3, or the convex T1 and the concave S2, they can have the same shape or different shapes based on practical requirements without any special limitations.

As shown in FIG. 3, three different regions are surrounded between the convexes T1˜T3 of the edge 201 and the reference line R1 respectively, and the areas of the three different regions are A_{T1}, A_{T2}, and A_{T3} respectively; three different regions are surrounded between the concaves S1˜S3 of the edge 201 and the reference line R1 respectively, and the areas of the three different regions are A_{S1}, A_{S2}, and A_{S3} respectively. Since the convex T1 and the concave S1 are symmetrical to the edge center D1, the area A_{T1} surrounded between the convex T1 and the reference line R1 is equal to the area A_{S1} surrounded between the concave S1 and the reference line R1.

Similarly, since the convex T2 and the concave S2 are symmetrical to the edge center D1, the area A_{T2} surrounded between the convex T2 and the reference line R1 is equal to the area A_{S2} surrounded between the concave S2 and the reference line R1. And so on, since the convex T3 and the concave S3 are symmetrical to the edge center D1, the area A_{T3} surrounded between the convex T3 and the reference line R1 is equal to the area A_{S3} surrounded between the concave S3 and the reference line R1.

From the above, if the total area of all regions surrounded between all convexes of the edge 201 and the reference line R1 is A_{T}, and the total area of all regions surrounded between all concaves of the edge 201 and the reference line R1 is As, then it can be found that A_{T}=A_{T1}+A_{T2}+A_{T3} and A_{S}=A_{S1}+A_{S2}+A_{S3}. Since A_{T1}=A_{S1}, A_{T2}=A_{S2}, and A_{T3}=A_{S3}, therefore A_{T}=A_{S}, that is to say, the total area A_{T} of all regions the edge 201 protruding outside the reference line R1 will be equal to the total area A_{S} of all regions the edge 201 depressing within the reference line R1.

It should be noticed that since the four edges 201˜204 of the touch pad 20 are the same, the edges 202, 203, and 204 will also have the same conditions as the above-mentioned edge 201. Therefore, the total area of all regions the edge 202 protruding outside the reference line R2 will be equal to the total area of all regions the edge 202 depressing within the reference line R2; the total area of all regions the edge 203 protruding outside the reference line R3 will be equal to the total area of all regions the edge 203 depressing within the reference line R3; the total area of all regions the edge 204 protruding outside the reference line R4 will be equal to the total area of all regions the edge 204 depressing within the reference line R4.

Above all, it can be found that the area of the touch pad 20 surrounded by the four edges 201˜204 is equal to the area of the conventional touch pad surrounded by the four reference lines R1˜R4. Because the four edges 201˜204 of the touch pad 20 and the adjacent touch pads 24, 26, 27, and 25 are embedded to each other respectively, the contact area and the mutual capacitance between the driving channel and the sensing channel will be increased, so that the sensitivity of the touch pads of the touch panel 2 for sensing the capacitance changing amount generated when touching will be also enhanced.

In practical applications, since the touch pads of the touch panel 2 in the invention have the same edges, that is to say, the vertical direction touch pad and the horizontal direction touch pad have the same pattern size, so that the driving direction and the sensing direction on the touch panel 2 can be exchanged. In order to lower the noise interference occurred when the touch panel 2 performs touch sensing, the touch panel 2 of the invention can change its original driving way, for example, some driving channels of the touch panel 2 can be connected to the ground to increase the capacitance of the sensing channel toward the ground. Therefore, the capability of the touch panel 2 for resisting noise can be enhanced to effectively improve the SNR of the entire touch sensing system.

It should be noticed that the touch panel designer can adjust the sensitivity and SNR of the touch panel 2, the resistance of the channels, and the required charging/discharging time by changing the edge shapes of the touch pads 20 of the touch panel 2, such as the length and the width of the embedded strips. For example, the designer can control the capacitance C and the resistance R of the channels to adjust its charging/discharging characteristic by changing the size of the embedded geometrical shape. In addition, the pattern of the touch pads 20 in the invention has simple shape and can be made by using a single layer of ITO glass and bridge; therefore, it is easy to be mass-produced and design-changed to fit the requirements of different kinds of touch panels.

Another embodiment of the invention is a touch pad applied in a touch panel. The touch pad includes a plurality of the same edges. Each edge includes two edge ends, an edge center, at least one convex, and at least one concave. A line between the two edge ends is defined as a reference line. The edge center is located at the center of the reference line. A first region is surrounded by the at least one convex and the reference line. A second region is surrounded by the at least one concave and the reference line. The at least one convex and the at least one concave are symmetrical to the edge center.

In practical applications, the area of the first region and the area of the second region can be the same or not. The number of the at least one convex and the number of the at least one concave are the same. A first convex of the at least one convex and a first concave of the at least one concave are corresponding and symmetrical to the edge center, the first convex and the first concave have a first shape in common. The first convex and the first concave are located at two sides of the edge center respectively. The first shape is selected from one of a group formed by a strip, a square, a triangle, an arc, a polygon, a sawtooth form, and an irregular geometric shape.

A second convex of the at least one convex and a second concave of the at least one concave are corresponding and symmetrical to the edge center, the second convex and the second concave have a second shape in common. The first shape and the second shape are the same or different. A sensitivity and a signal-noise ratio of the touch panel can be adjusted by changing the design of the at least one convex and the at least one concave.

Since the touch pad applied in the touch panel has been explained in detail in the above-mentioned embodiment, no further description is provided here.

Compared to prior arts, the touch panel and its touch pad of the invention is to change the shape of the edges of the touch pads and maintain the original area of the touch pad, so that the touch pads of vertical direction and horizontal direction can be embedded each other to increase the touch area and the mutual capacitance between the driving channel and the sensing channel, and the sensitivity of the touch pad can be also enhanced.

In addition, under the condition of setting the non-driving channels or the non-sensing channels of the touch panel in the invention, the capacitance of the sensing channel toward ground can be increased, so that its capability of resisting noises can be enhanced to effectively improve the SNR of the entire touch sensing system. The touch panel and its touch pad of the invention can not only increase the sensitivity of the touch pads and improve the SNR to solve the problem of the conventional diamond structure, but also keep the advantage of the conventional diamond structure made by using a single layer of ITO glass and a bridge. Therefore, the competitiveness of the touch panel on the market can be largely enhanced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A touch pad, applied in a touch panel, the touch pad comprising:
a plurality of edges, the plurality of edges being the same, each of the plurality of edges comprising:
two edge ends, a line connecting the two edge ends being defined as a reference line;
an edge center, located at a center of the reference line;
at least one convex, the at least one convex and the reference line surrounding a first region; and
at least one concave, the at least one concave and the reference line surrounding a second region;
wherein the at least one convex and the at least one concave are symmetrical to the edge center.

2. The touch pad of claim 1, wherein the number of the at least one convex and the number of the at least one concave are the same.

3. The touch pad of claim 1, wherein a first convex of the at least one convex and a first concave of the at least one concave are corresponding and symmetrical to the edge center, the first convex and the first concave have a first shape in common.

4. The touch pad of claim 3, wherein the first convex and the first concave are located at two sides of the edge center respectively.

5. The touch pad of claim 3, wherein the first shape is selected from one of a group formed by a strip, a square, a triangle, an arc, a polygon, a sawtooth form, and an irregular geometric shape.

6. The touch pad of claim 3, wherein a second convex of the at least one convex and a second concave of the at least one concave are corresponding and symmetrical to the edge center, the second convex and the second concave have a second shape in common.

7. The touch pad of claim 6, wherein the first shape and the second shape are the same or different.

8. The touch pad of claim 1, wherein the area of the first region and the area of the second region are the same.

9. The touch pad of claim 1, wherein a sensitivity and a signal-noise ratio of the touch panel can be adjusted by changing the design of the at least one convex and the at least one concave.

10. A touch panel, comprising:
a plurality of touch pads of claim 1, comprising:
a plurality of first touch pads, aligned along a first direction; and
a plurality of second touch pads, aligned along a second direction;
wherein a first touch pad of the plurality of first touch pads and a second touch pad of the plurality of second touch pads are embedded to increase a contact area and a mutual capacitance between the first touch pad and the second touch pad.

11. A touch panel, comprising:
a plurality of touch pads of claim 2, comprising:
a plurality of first touch pads, aligned along a first direction; and
a plurality of second touch pads, aligned along a second direction;
wherein a first touch pad of the plurality of first touch pads and a second touch pad of the plurality of second touch pads are embedded to increase a contact area and a mutual capacitance between the first touch pad and the second touch pad.

12. A touch panel, comprising:
a plurality of touch pads of claim 3, comprising:
a plurality of first touch pads, aligned along a first direction; and
a plurality of second touch pads, aligned along a second direction;
wherein a first touch pad of the plurality of first touch pads and a second touch pad of the plurality of second touch pads are embedded to increase a contact area and a mutual capacitance between the first touch pad and the second touch pad.

13. A touch panel, comprising:
a plurality of touch pads of claim 4, comprising:
a plurality of first touch pads, aligned along a first direction; and
a plurality of second touch pads, aligned along a second direction;
wherein a first touch pad of the plurality of first touch pads and a second touch pad of the plurality of second touch pads are embedded to increase a contact area and a mutual capacitance between the first touch pad and the second touch pad.

14. A touch panel, comprising:
a plurality of touch pads of claim 5, comprising:
a plurality of first touch pads, aligned along a first direction; and
a plurality of second touch pads, aligned along a second direction;
wherein a first touch pad of the plurality of first touch pads and a second touch pad of the plurality of second touch pads are embedded to increase a contact area and a mutual capacitance between the first touch pad and the second touch pad.

15. A touch panel, comprising:
a plurality of touch pads of claim 6, comprising:
a plurality of first touch pads, aligned along a first direction; and
a plurality of second touch pads, aligned along a second direction;
wherein a first touch pad of the plurality of first touch pads and a second touch pad of the plurality of second touch pads are embedded to increase a contact area and a mutual capacitance between the first touch pad and the second touch pad.

16. A touch panel, comprising:
a plurality of touch pads of claim 7, comprising:
a plurality of first touch pads, aligned along a first direction; and
a plurality of second touch pads, aligned along a second direction;
wherein a first touch pad of the plurality of first touch pads and a second touch pad of the plurality of second touch pads are embedded to increase a contact area and a mutual capacitance between the first touch pad and the second touch pad.

17. A touch panel, comprising:
a plurality of touch pads of claim 8, comprising:
a plurality of first touch pads, aligned along a first direction; and
a plurality of second touch pads, aligned along a second direction;
wherein a first touch pad of the plurality of first touch pads and a second touch pad of the plurality of second touch pads are embedded to increase a contact area and a mutual capacitance between the first touch pad and the second touch pad.

18. A touch panel, comprising:
a plurality of touch pads of claim 9, comprising:
a plurality of first touch pads, aligned along a first direction; and
a plurality of second touch pads, aligned along a second direction;
wherein a first touch pad of the plurality of first touch pads and a second touch pad of the plurality of second touch pads are embedded to increase a contact area and a mutual capacitance between the first touch pad and the second touch pad.
